(19) United States
(12) Patent Application Publication
(10) Pub. No.: US 2026/0192663 A1
(43) Pub. Date: Jul. 9, 2026

(54) SYSTEM FOR OPERATING FUNCTIONS OF A TRAILER VEHICLE

(71) Applicant: ZF CV Systems Global GmbH, Bern (CH)

(72) Inventors: Tim Meyer, Hannover (DE); Jan-Christoph Von Der Beeke, Algermissen (DE); Axel Stender, Hameln (DE); Andelko Glavinic, Sarstedt (DE); Tobias Wosnitza, Lübbecke (DE)

(21) Appl. No.: 19/467,371

(22) Filed: Feb. 2, 2026

Related U.S. Application Data
(63) Continuation of application No. PCT/EP2024/069866, filed on Jul. 12, 2024.

(30) Foreign Application Priority Data
Jul. 31, 2023 (DE) 10 2023 120 277.4

(51) Int. Cl. B60K 35/10; B60K 35/22

(52) U.S. Cl. CPC B60K 35/10; B60K 35/22; B60K 2360/111; B60K 2360/1438; B60K 2360/171

(57) ABSTRACT

In a system for operating functions of a trailer vehicle in a towing vehicle assigned to the trailer vehicle, the trailer vehicle, in order to carry out the functions, includes a control unit or a plurality of control units as well as actuators, sensors and operating devices which are able to be addressed via the control unit or the control units. Data is transmitted between at least one control unit of the trailer vehicle and at least one control unit of the towing vehicle via a data interface. In order to operate functions of the trailer vehicle, an operating device provided in the towing vehicle and communicating with the control unit of the towing vehicle is provided, which operating device is configured to represent state-describing signals of the trailer vehicle and to input control commands for functions of the trailer vehicle.

### CROSS-REFERENCE TO RELATED APPLICATIONS

This application is a continuation application of international patent application PCT/EP2024/069866, filed Jul. 12, 2024, designating the United States and claiming priority from German application 10 2023 120 277.4, filed Jul. 31, 2023, and the entire content of both applications is incorporated herein by reference.

### TECHNICAL FIELD

The disclosure relates to a system for operating functions of a trailer vehicle in a towing vehicle assigned to the trailer vehicle, wherein the trailer vehicle, in order to carry out the functions, includes a control unit or a plurality of control units as well as actuators or operating devices and sensors which are able to be addressed via the control unit or control units, and wherein data is transmitted between at least one control unit of the trailer vehicle and at least one control unit of the towing vehicle via a data interface. The disclosure also relates to a commercial vehicle train, the towing vehicle of which includes such an operation system as well as a computer program in the form of application software (an app) for such an operation system.

### BACKGROUND

Nowadays, the operation of commercial vehicles in the form of trailer vehicles connected to towing vehicles requires comprehensive control and monitoring of all important vehicle functions ideally in real time and manageable such that required interventions are able to be carried out from a central point/a central unit without great effort. This applies both to an operating state during a journey and to stationary shunting and loading operations.

In trailer vehicles, these important and, as a general rule, load-dependent systems/functions also include electronic braking systems or electronically controlled air suspension systems, which have to be accessible to such control and monitoring. In the domain of stationary shunting and loading operations and also during the journey, solutions are known in the prior art for this.

For instance, US 2003/0168908A1 discloses a braking control system for a towed vehicle (trailer), in which the control module is arranged in the towing vehicle such that it can be easily operated by the driver. In the control module, various states of the braking control system of the trailer are able to be processed. The control module also includes a readout and a brake lever for manual braking.

DE 100 33 345 A1 discloses a commercial vehicle including a towing vehicle and at least one trailer, in which the trailer includes a control device which is actuated via a radio link and which is connected to electrical functional devices in the trailer. The control device is in turn connected via a radio link to an operating and/or monitoring device arranged in a towing vehicle.

Also known are embodiments in which, for example, devices/functions of trailer vehicles can be controlled via application software on mobile devices or else via a remote control arranged in a driver's cabin of a towing vehicle (trailer remote control),

### SUMMARY

It is an object of the disclosure to provide a further-improved system for operating functions of a trailer vehicle in a towing vehicle assigned to the trailer vehicle, which system simplifies handling by the driver/vehicle operator and is able to be safely operated in an ergonomically improved form and is able to be integrated into the driver's cabin/into the driver's surroundings.

This object is achieved by a system for operating functions of a trailer vehicle according to various embodiments of the disclosure. Also disclosed is a commercial vehicle train including such a system as well as a computer program in the form of application software for such a system.

According to the disclosure, in order to operate functions of the trailer vehicle, an operating device provided in the towing vehicle and communicating with the control unit of the towing vehicle is provided, which operating device is configured to represent state-describing signals of the trailer vehicle and to input control commands for functions of the trailer vehicle.

Combining the representation of state-describing signals with the possibility of inputting control commands within an operating device facilitates the direct and immediate response of the vehicle operator/driver to changes. The frequently existing separation of readouts of state-describing signals, for example a readout of a signal via a warning light, and the actuation of a switch physically remote therefrom in response to the signal is omitted here. In this way, operating errors are reduced and a faster and safe response is made possible.

Various embodiments of the disclosure consist in the operating device being configured as a display provided in the towing vehicle, in particular as a display assigned to a vehicle operator. Such displays can be produced in different sizes and shapes and also allow, for example, different signals or measured values of the vehicle to be represented alternately. In a further configuration, the display provided in the towing vehicle for operating functions of a trailer vehicle is provided as an additional display next to further displays or monitors for the functions of the towing vehicle.

According to various embodiments of the disclosure, an operating application for functions of the trailer vehicle is capable of running on the display, which application includes representations of state-describing signals of the trailer vehicle which appear in an event-controlled manner or which are able to be called up via touch-sensitive areas of the display via touch functions, and inputs of control commands for the trailer vehicle which are able to be carried out via touch-sensitive areas of the display via touch functions. Such touch functions allow signals/information to be called up and control commands to be input by simply tapping on touch-sensitive areas of a display and are therefore particularly easy for a vehicle operator to operate.

In a further configuration of the disclosure, control commands for the trailer vehicle are input via operating elements assigned to the display or located on the display, preferably via keys or push buttons. This also results in easy and ergonomic operability for the driver.

In a further configuration of the disclosure, the display of the operating system is configured as a display of a mirror replacement system or is integrated within the display of an existing mirror replacement system. The state-describing signals of the trailer vehicle (trailer information) and the associated operating options via control commands are therefore always in the driver's field of vision. In particular with the increasing use and acceptance of autonomous driving, such integration within a mirror replacement system constitutes a simple solution because the vehicle operator then only has to be able to intervene manually in control of the trailer functions over the so-called “last mile” and or during shunting operation.

A further configuration of the disclosure consists in the data transmission being carried out according to a standardized Ethernet protocol. Such a data transmission protocol is adapted to use in vehicles and allows better and higher data transmission than is present in existing bus systems, for example.

In a further configuration of the disclosure, the representation of state-describing signals of the trailer vehicle and the input of control commands for functions of the trailer vehicle relate to an electronic braking system provided in the trailer vehicle and/or an electronically controlled air suspension system. These two systems, which are very important for safety, rely on the processing of a large number of measured variables for their operation, which measured variables are processed by control units and transformed into signals for the associated switching devices, so that a particular relevance for information and for any required intervention via an operating system arises.

In a commercial vehicle train including a towing vehicle and a trailer vehicle, in which the towing vehicle is equipped with a system according to the disclosure for operating functions of the trailer vehicle, the advantages of the system are particularly evident. In this case, the commercial vehicle train may have only one trailer vehicle or a plurality of trailer vehicles.

The aforementioned object is also achieved by a computer program in the form of application software (an app) for an operation system according to the disclosure, wherein the computer program is built such that state-describing signals of a trailer vehicle which are transmitted by a control unit or a plurality of control units are able to be represented on a display of a towing vehicle connected to the trailer vehicle, wherein the representation is able to be called up via touch-sensitive fields on the display and/or takes place in an event-controlled manner, and wherein the computer program is furthermore configured such that output signals for controlling functions of the trailer vehicle which are generated via touch-sensitive fields on the display or via operating elements assigned to the display are able to be transmitted to a control unit.

### BRIEF DESCRIPTION OF DRAWINGS

The invention will now be described with reference to the drawings wherein:

FIG. 1 shows, in the form of a schematic diagram, a commercial vehicle train, formed with a semi-trailer, composed of a towing vehicle and a trailer vehicle in the form of a semi-trailer, provided with a system according to the disclosure for operating functions of the trailer vehicle;

FIG. 2 shows the basic configuration of the system according to the disclosure for operating functions of the trailer vehicle in a block diagram represented in a simplified manner; and,

FIG. 3 shows a basic representation of a driver's cabin, as it appears from the perspective of a vehicle operator looking forward.

### DETAILED DESCRIPTION

In the figures, the same or similar elements are referenced using the same reference signs. In order to clarify the disclosure, it is advantageous to look at the FIGS. in the synopsis.

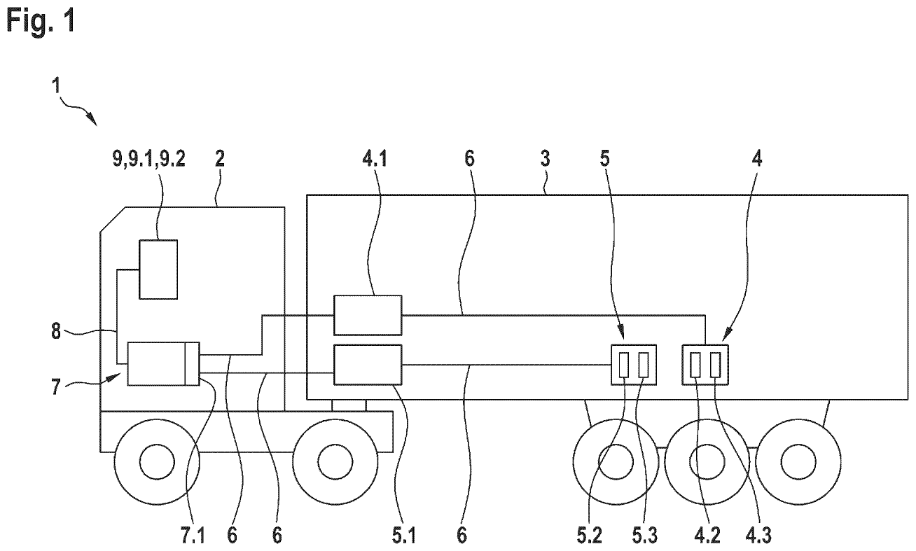

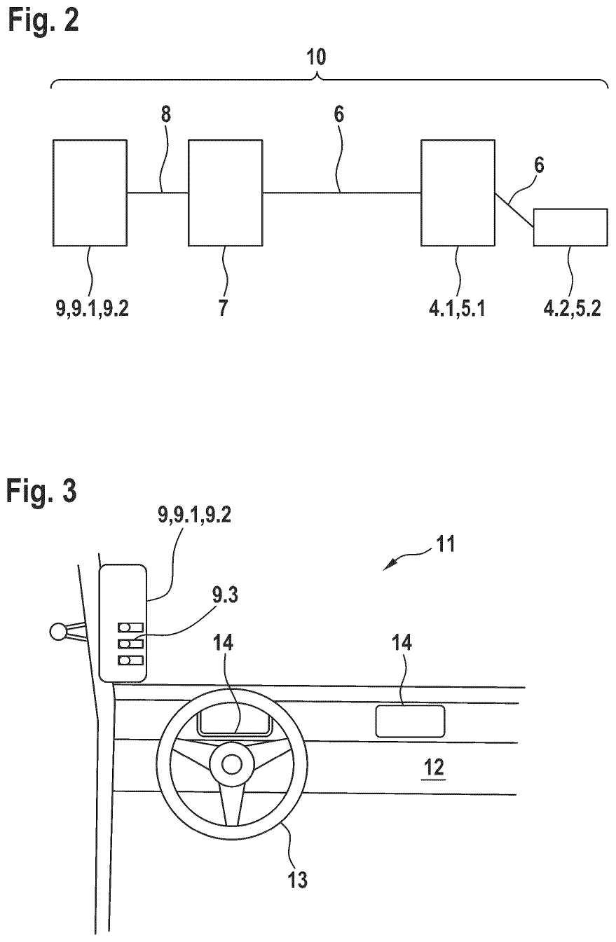

FIG. 1 shows, in the form of a schematic diagram, a commercial vehicle train 1, formed with a semi-trailer, including a towing vehicle 2 and a trailer vehicle 3 (trailer) in the form of a semi-trailer. The towing vehicle 2 includes a system 10 according to the disclosure for operating functions of the trailer vehicle 3, represented as a simple block diagram in FIG. 2. The trailer vehicle 3, in order to carry out the functions, includes a control unit or a plurality of control units, here a control unit 4.1 for controlling actuators 4.2 and processing the signals from sensors 4.3 of an electronic braking system 4 provided in the trailer vehicle 3 as well as a control unit 5.1 for controlling actuators 5.2 and processing the signals from sensors 5.3 of an electronically controlled air suspension system 5 provided in the trailer vehicle 3.

Data is transmitted between the control units 4.1, 5.1 of the trailer vehicle 3 and a control unit 7 of the towing vehicle 2 via data lines 6 and a data interface 7.1.

In order to operate functions of the electronic braking system 4 and of the electronically controlled air suspension system 5 in the trailer vehicle 3, an operating device 9 provided in the towing vehicle 2 and communicating with the control unit 7 of the towing vehicle 2 via a data line 8 is provided, which operating device is used, on the one hand, to represent signals which are transmitted via the corresponding control units 4.1 and 5.1 of the trailer vehicle 3 and the control unit 7 of the towing vehicle 2 and which describe the state of the electronic braking system 4 and of the electronically controlled air suspension system 5 in the trailer vehicle 3. On the other hand, the operating device 9 is also configured to input control commands for functions of the electronic braking system 4 and of the electronically controlled air suspension system 5 in the trailer vehicle 3, wherein the control commands are activated and forwarded via the control unit 7 of the towing vehicle 2 and the corresponding control units 4.1 and 5.1 of the trailer vehicle 3.

In this case, the operating device 9 is configured as a display 9.1 provided in the towing vehicle 2 and assigned to the vehicle operator.

The fundamental basic configuration of the system 10 according to the disclosure for operating functions of the trailer vehicle 3 is once again shown in a block diagram in FIG. 2 represented in a simplified manner.

FIG. 3 shows a likewise only basic representation of a driver's cabin 11, as it is from the perspective of a vehicle operator looking forward. Visible are the dashboard 12, the steering wheel 13 as well as an operating device 9 configured as a display 9.1 of a mirror replacement system assigned to the vehicle operator. Further readouts and displays 14 arranged in the dashboard 12 are also visible.

An operating application, which is not described further here, for functions of the trailer vehicle is capable of running on the display 9.2 of the mirror replacement system, which application includes representations of state-describing signals of the trailer vehicle 3 which appear in an event-controlled manner or which are able to be called up via touch-sensitive areas 9.3 of the display 9.2 via touch functions. The touch-sensitive areas 9.3 here are configured such that inputs of control commands for the trailer vehicle 3, which are able to be carried out via touch functions, are also made possible here.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Commercial vehicle train
2 Towing vehicle
3 Trailer vehicle
4 Braking system in the trailer vehicle
4.1 Control unit of the braking system 4
4.2 Actuators of the braking system 4
4.3 Sensors of the braking system 4
5 Electronically controlled air suspension system in the trailer vehicle
5.1 Control unit of the air suspension system 5
5.2 Actuators of the air suspension system 5
5.3 Sensors of the air suspension system 5
6 Data line
7 Control unit in the towing vehicle
7.1 Interface, data interface
8 Data line
9 Operating device
9.1 Display/operating device
9.2 Display of a mirror replacement system
9.3 Touch-sensitive area
10 System for operating functions of the trailer vehicle
11 Driver's cabin
12 Dashboard
13 Steering wheel
14 Readout, display, monitor

1. A system for operating functions of a trailer vehicle in a towing vehicle assigned to the trailer vehicle, the trailer vehicle, in order to carry out functions, including a trailer control unit as well as a plurality of actuators and sensors which are able to be addressed via the trailer control unit, wherein data is transmitted between the trailer control unit and a towing vehicle control unit of the towing vehicle via a data interface, the system comprising:
an operating device for the operating functions of the trailer vehicle, said operating device being provided in the towing vehicle and configured to communicate with the towing vehicle control unit of the towing vehicle; and,
said operating device being configured to represent state-describing signals of the trailer vehicle and to input control commands for the operating functions of the trailer vehicle.

2. The system for the operating functions of the trailer vehicle of claim 1, wherein said operating device is configured as a display provided in the towing vehicle.

3. The system for the operating functions of the trailer vehicle of claim 2, wherein an operating application for the operating functions of the trailer vehicle is configured to run on the display, said operating application including representations of the state-describing signals of the trailer vehicle which appear in an event-controlled manner or which are able to be called up via touch-sensitive areas of the display via touch functions, and the input of the control commands for the trailer vehicle which are able to be carried out via the touch-sensitive areas of the display via the touch functions.

4. The system for the operating functions of the trailer vehicle of claim 1, wherein an operating application for the operating functions of the trailer vehicle is capable of running on a display, which operating application includes representations of the state-describing signals of the trailer vehicle which appear in an event-controlled manner or which are configured to be called up via touch-sensitive areas of the display via touch functions, wherein the control commands for the trailer vehicle are input via operating elements assigned to the display or located on the display.

5. The system for the operating functions of the trailer vehicle of claim 2, wherein said display is a display of a mirror replacement system.

6. The system for the operating functions of the trailer vehicle of claim 1, wherein the data is transmitted according to a standardized Ethernet protocol.

7. The system for the operating functions of the trailer vehicle of claim 2, wherein the display provided in the towing vehicle for the operating functions of the trailer vehicle is provided as an additional display next to further displays or monitors for the operating functions of the towing vehicle.

8. The system for the operating functions of the trailer vehicle of claim 2, wherein the representation of the state-describing signals of the trailer vehicle and the input of the control commands for the operating functions of the trailer vehicle relate to at least one of an electronic braking system provided in the trailer vehicle and an electronically controlled air suspension system.

9. The system for the operating functions of the trailer vehicle of claim 2, wherein said display is assigned to a vehicle operator.

10. The system for the operating functions of the trailer vehicle of claim 4, wherein the control commands for the trailer vehicle are input via keys or push buttons.

11. A commercial vehicle train comprising:
a towing vehicle having a towing vehicle control unit;
a trailer vehicle;
said towing vehicle including a system for operating functions of said trailer vehicle during said towing;
said trailer vehicle, in order to carry out the operating functions, including a trailer control unit as well as a plurality of actuators and sensors which are able to be addressed via said trailer control unit;
wherein data is transmitted between said trailer control unit and said towing vehicle control unit of said towing vehicle via a data interface;
said system including an operating device for the operating functions of the trailer vehicle, said operating device being provided in the towing vehicle and configured to communicate with the towing vehicle control unit of the towing vehicle; and,
said operating device being configured to represent state-describing signals of the trailer vehicle and to input control commands for functions of the trailer vehicle.

12. A computer program in a form of application software for the system for operating functions of a trailer vehicle of claim 1, the computer program comprising:
program code stored on a non-transitory computer-readable medium;
the program code being further configured to enable state-describing signals of the trailer vehicle which are transmitted by one or more control units to be represented on a display of a towing vehicle connected to the trailer vehicle, wherein the representation is able to be called up via touch-sensitive fields on the display and/or takes place in an event-controlled manner;
the program code being further configured to transmit output signals for controlling the operating functions of the trailer vehicle which are generated via the touch-sensitive fields on the display or via operating elements assigned to the display and are able to be transmitted to the one or more control units.
